(19) United States
(12) Patent Application Publication
(10) Pub. No.: US 2006/0236765 A1
(43) Pub. Date: Oct. 26, 2006

(54) Method for the mechanical characterization of a metallic material

(75) Inventors: Bernard Bouet, Gretz Armainvilliers (FR); Stephane Kerneis, Velizy (FR); Claude Andre Charles Pagnon, Vaux Sur Mer (FR); Eric Christian Jean Pinto, Fleury En Biere (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignees: SNECMA, Paris (FR); SNECMA SERVICES, Paris (FR)

(21) Appl. No.: 11/360,702

(22) Filed: Feb. 24, 2006

(30) Foreign Application Priority Data
Feb. 25, 2005 (FR) 0550518
Jul. 29, 2005 (FR) 0508150

(51) Int. Cl. G01N 29/00; G01H 13/00; G01H 1/00

(52) U.S. Cl. 73/577; 73/583; 73/579

(57) ABSTRACT

The method allows the mechanical characterization of a metallic material relative to a material constituting a part to be repaired and the validation of an installation for repairing said part by build-up welding with said metallic material. According to this method, a cavity is machined in a bar of said metal, the cavity is build-up welded by means of said installation, a test piece is cut from said bar so that it has a central zone consisting only of build-up weld metal and the test piece is subjected to an axial vibration fatigue test.

The present invention relates to the field of turbomachines, especially aeronautical turbomachines, and is intended for the repair of parts such as moving bladed discs.

To meet the increased performance requirements of engines, one-piece bladed discs or wheels, called “blisks”, are now manufactured from titanium alloy for the compressors of gas turbine engines. In a conventional rotor, the blades are retained by their root, which is fitted into a housing made on the rim of the disc. The discs and blades are therefore manufactured separately before being assembled into a bladed rotor. In a blisk, the blades and the disc are machined directly from a forged blank—they form a single part. This technique permits substantial savings in the total weight of the engine, but also substantial reductions in manufacturing costs.

However, this type of rotor has the drawback of being difficult to repair. In operation, the compressor blades may undergo damage due to impacts caused by the ingestion, via the engine, of foreign bodies or else due to erosion caused by dust and other particles entrained by the air flowing through the engine and coming into contact with the surface of the blades. This wear or damage, if it cannot be repaired according to the criteria specified in the manufacturer's documentation, involves replacing one or more defective blades. In the case of one-piece bladed components, the blades are integral parts of a massive component and, unlike in conventional arrangements, they cannot be replaced or even removed in order to be repaired individually. It is necessary to repair the part directly on the disc. The repair must therefore take into account all aspects of the component, with its size, its weight and, in the case of large components, accessibility to the zones to be repaired.

Thus, in the case of a blisk, the regions generally concerned by repair are, for each blade, the tip, the aerofoil corner on the leading edge side, the aerofoil corner on the trailing edge side, the leading edge and the trailing edge.

The repair techniques that have been developed consist in removing the damaged region on the damaged blades and then in replacing the removed portion with a part of suitable shape, or else by build-up welding. These techniques generally employ a conventional machining operation, for removing the damaged portion, contactless inspection of the repaired part, ultrasonic peening and specific machining for re-work of the repaired zone.

The present invention relates to repair by build-up welding.

Repair is particularly difficult to carry out in the case of certain alloys used, the welding of which results in the formation of volume defects. This is especially so for the titanium alloy Ti17. This alloy is mentioned for example in the Applicant's patent application EP 1 340 832, which relates to a product, such as a blade, made of this material. When performing build-up welding, the TIG or microplasma techniques conventionally and widely used in the aeronautical industry only allow titanium Ti17 to be treated for applications limited to lightly stressed zones.

These conventional build-up welding techniques result in the formation of defects. Thus, TIG build-up welding, employing a substantial amount of energy compared with the small thickness involved, generates strains and leads to the formation of a large number of pores, such as micropores or microblisters, and also an extended heat-affected zone (HAZ). These micropores, which are not very easily detectable, generate a weakening in the mechanical properties by up to 80%. This type of build-up welding is therefore applicable only to lightly stressed zones. Microplasma build-up welding results in the formation of a smaller HAZ, but it is still relatively large. Furthermore, the method requires particular attention and a periodic inspection of the equipment and products used, so that no operating parameter of the machine drifts and modifies the expected results.

U.S. Pat. No. 6,568,077 describes a method of repairing a blade on a blisk in which the damaged portion of the blade is machined and then, in a first operating mode, the missing portion is built up by deposition of metal by means of a tungsten-electrode arc-welding (TIG) machine. In a second operating mode, an insert is welded by means of an electron-beam welding machine. The profile of the blade is then restored by appropriate machining. However, this method does not mention the problem encountered when welding certain titanium alloys.

In particular, laser build-up welding is a technique that prevents the defects in the weld zone.

Laser build-up welding is already known and used, for example in applications where metal contours have to be generated, especially from CAD data. The walls have a thickness of between 0.05 and 3 mm and the layers are 0.05 to 1 mm in height. The technique makes it possible to achieve excellent metallurgical bonding to the substrate.

The technique of build-up welding by means of a laser beam has the following advantages: the heat influx is constant over time. Heat has no time to accumulate within the volume and to diffuse—it follows that there is little outgassing in the case of titanium and a limited reduction in strength. Furthermore, the repeatability and reliability of this technique are good, once the machine parameters have been set, and it is easily controlled.

The laser techniques currently employed involve simultaneously adding filler material and radiating the substrate with the laser beam. The material is generally deposited in the work zone in the form of a powder or a metal wire. In other versions, it is sprayed in the form of powder jets into the work zone using a suitable nozzle.

However, such a method is tricky to implement.

Firstly, it is necessary to ensure that the build-up weld metal is suitable for the repair without prejudicially weakening the mechanical properties of the repaired zone.

Secondly, it is also necessary for the installation in question to be capable of making a repair without prejudicially weakening the properties of the material either.

The subject of the invention is therefore a method for the mechanical characterization of a metallic material relative to a metal constituting a part to be repaired and for validating an installation for repairing said metal part by build-up welding with said metallic material, characterized in that it consists in:
machining a cavity in a bar made of the metal of the part to be repaired;
build-up welding the cavity by means of said installation using said metallic material;
cutting a test piece from said bar so that it has a central zone consisting only of the build-up weld metal; and
subjecting the test piece to an axial vibration fatigue test in order to determine the weakening of the mechanical properties with respect to the constituent metal of the part.

If, in order to repair parts, the manufacturer or the user of the machines makes use of subcontractors of any origin, possibly using alloys that are not identical to the alloy of which the parts are made, it is important to have a simple means for checking that the parts can be repaired satisfactorily. The method of the invention therefore meets this objective. All that is required is for the manufacturer or the user to supply the subcontractor with a series of the abovementioned test pieces and for the subcontractor to return them to the manufacturer or the user after having carried out a build-up welding operation according to the present method. The analysis carried out on the specimens after fracture resulting from the tests will give a precise image of the capability to produce a satisfactory repair in terms of mechanical properties.

The method employs an installation preferably of the laser build-up welding type, however, it remains applicable to any type of build-up welding.

The method employs in particular a metallic material consisting of a titanium alloy, especially Ti17 or TA6V, for a part also made of titanium alloy.

Advantageously, the bar has a parallelepipedal shape and the cavity machined in the bar has a shape corresponding to that made in the part to be repaired. In particular, the cavity is cylindrical with an axis transverse to the bar.

The invention will now be described in greater detail with reference to the appended drawings in which:

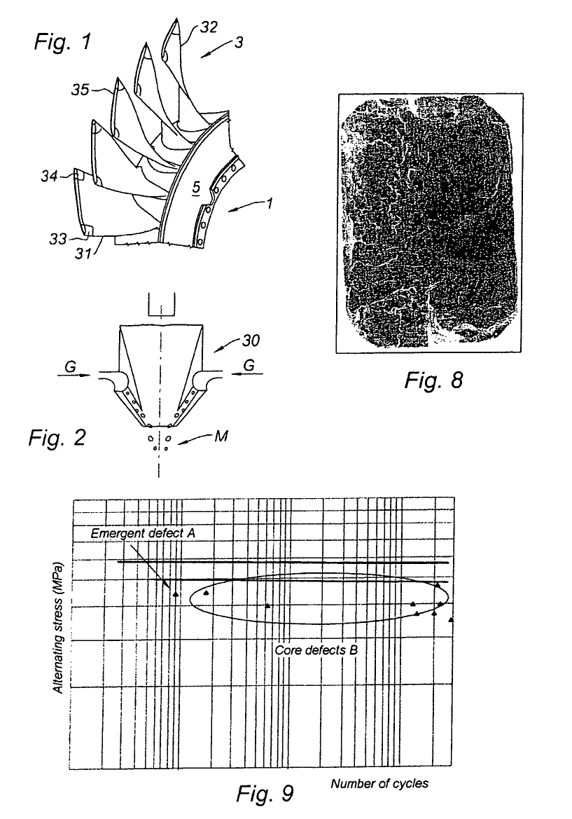

FIG. 1 shows a partial view of a one-piece bladed disc;

FIG. 2 shows a schematic sectional view of a build-up welding nozzle;

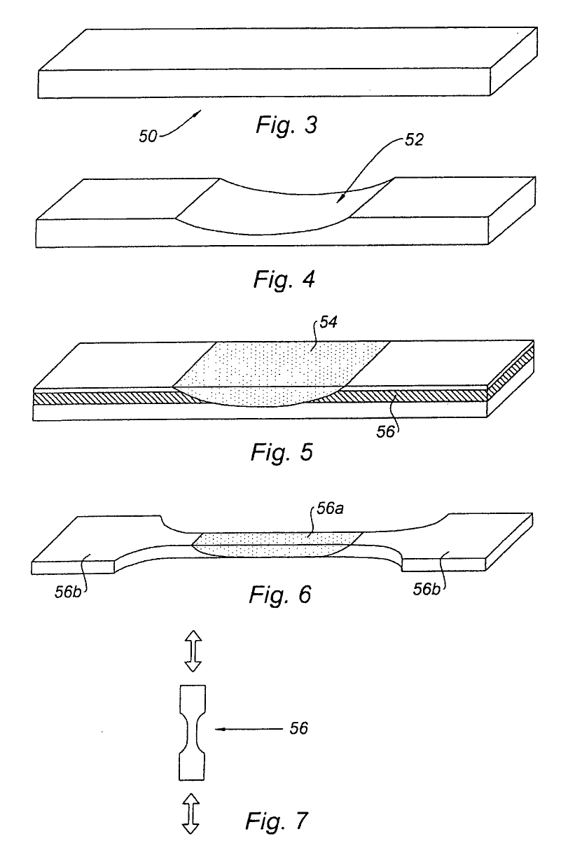

FIGS. 3 to 6 show a mechanical characterization test piece with a laser build-up weld according to the invention;

FIG. 7 shows the vibration fatigue test on a build-up welded test piece;

FIG. 8 shows a macrograph of the fracture surface; and

FIG. 9 shows a graph for analysing the test results.

FIG. 1 shows part of a one-piece bladed disc 1. The blades 3 are radial and distributed around the periphery of a disc 5. The assembly is a one-piece assembly in the sense that it is manufactured either by machining from a single blank or by welding at least part of its components. The blades in particular are not joined to the disc by disconnectable mechanical means. The zones liable to be damaged are the leading edges 31, the trailing edges 32, the leading edge corners 33, the trailing edge corners 34 and the line of the aerofoil tip 35 provided with a thinned portion forming a sealing lip as is known.

The damage observed depends on the position of the zone. On the leading edge, trailing edge or aerofoil corner for example, this may be a loss of material caused by the impact of a foreign body or else a crack. At the aerofoil tip, this is more often wear due to rubbing with the engine casing.

Depending on the damaged zone, a quantity of material is removed in such a way that the geometry, the dimensions and the sides of the zone to be repaired are determined. This shaping operation is performed by mechanical machining, especially by milling using a suitable tool, in a range ensuring a surface finish compatible with the desired quality of the build-up welding.

A welding surface intended to receive the filler metal is then cleaned, both mechanically and chemically. This cleaning is tailored to the material of the substrate. This is important in the case of the titanium alloy Ti17 in particular, or the alloy TA6V.

FIG. 2 shows a laser build-up welding nozzle 30. This nozzle has channels for feeding a metal powder to be deposited on the zone to be repaired along the laser beam propagation axis. The beam is directed onto the part and the metal powder M is entrained by a stream of gas G into the zone heated by the beam.

The nozzle moves along the zone to be repaired in a two-and-fro movement, progressively building up a stack of layers of material deposited and melted by the laser beam. The build-up welding is carried out with a constant speed and intensity, even if the thickness varies along the part.

The parameters are adapted, in particular so as to limit the internal strains and any remachining, and also the extent of the heat-affected zone (HAZ). The parameters to be taken into account in the build-up welding are:
the height of the focal point of the laser beam (preferably a YAG laser) above the surface;
the speed of advance of the head 30;
the energy applied by the beam;
the powder used (Ti17 or TA6V) which is not necessarily the same metal as the substrate, its particle size, which is preferably between 30 and 100 μm, and its focal point; and
the nature of the entrainment or confinement gas, which is preferably helium or argon.

The type of nozzle to be used is defined beforehand. The speed and energy are dependent on the type of machine employed.

In particular, in the case of titanium Ti17, to prevent the appearance of porosity within the volume, it has been found that the parameters must not vary by more than ±5%.

The invention relates to the validation of a laser welding installation for implementing the build-up welding repair method. Specifically, before a machine is put into service and dedicated to repairing a blisk by build-up welding, it is necessary to check whether the repaired parts will not suffer any prejudicial weakening during their use.

This validation is performed by carrying out tests on what are called characterization and validation test pieces. These test pieces 50 shown in FIGS. 3 to 6 make it possible:
to check visually for the absence of oxidation and to measure the geometry of the build-up weld;
to evaluate the metallurgical quality of the build-up weld after machining, with and without heat treatment, by non-destructive and destructive tests, such as a dye penetration test and micrographic sections; and
to characterize the laser build-up welded Ti17 material, after machining and heat treatment, in terms of mechanical properties, that is to say by carrying out cyclic fatigue (HCF) tests.

In the particular case of a blisk repair, it is preferred to use a bar 50 obtained from a forged blisk blank, as this will then have a fiberizing direction of the same nature as the blisks that will be repaired with such an installation. To carry out these tests, the bar is parallelepipedal with, for example, the following dimensions: 100 mm×19 mm×8 mm.

As may be seen in FIG. 4, a depression 52 is machined with the geometry of the profile corresponding to a cavity that will be cut from a damaged zone of the leading or trailing edge of an aerofoil in order to form a zone to be repaired. Here, this cavity has a cylindrical shape, the axis of which is transverse with respect to that of the bar.

The bar 50 is wider than an aerofoil. This depression 52 is build-up welded, FIG. 5, by means of the installation that it is desired to validate. The cavity has a sufficient depth, for example a maximum depth of 5 mm, so that it is necessary to carry out the method by forming a stack of several layers. Moreover, owing to the width of the bar, the build-up welding is performed by crossing the various layers.

When the weld has been completed, as shown in FIG. 5, possibly with a few overhangs, considered to be of no consequence, a slice 56 is cut from the bar. This slice 56, shown hatched in FIG. 5, includes the build-up welded portion 54. As may be seen in the figure, the slice is parallel and slightly set back, for example by 1 mm, relative to the surface on which the build-up welding was carried out. For example, for a bar 8 mm in thickness, a slice 2.5 mm in thickness is extracted. This slice therefore has three distinctive portions, with a central portion consisting solely of the build-up weld metal between two elements of the original bar.

FIG. 6 shows this slice 56, which is machined in order to obtain a central portion 56a forming a bar incorporating the build-up weld zone. In its central portion, the entire thickness of the bar 56a is made of build-up weld material. On either side of the bar 56a, wider tabs 56b form tabs for being gripped by the jaws of the machine on which the cyclic fatigue tests are carried out.

These tests, shown diagrammatically in FIG. 7, consist in applying alternately compressive axial forces and tensile axial forces. The frequency, the amplitude of the vibrations, the number of cycles and the temperature, in particular, are determined.

FIG. 8 shows a macrograph of the surface of the fractured test piece. The test piece is fractured in the build-up weld zone. Examination of this surface makes it possible to verify the quality of the build-up welding and to observe the nature of the defects present. The level of the alternating stress in MPa is plotted, for various test pieces, as a function of the number of cycles, on a graph with a logarithmic scale on the x-axis, and the number of cycles after which fracture occurs is noted. For example, on this graph, for a specimen consisting of several test pieces, the occurrence of the fracture of the various test pieces, caused by an emergent fault A or by core faults B, has been plotted.

By analysing the results, the level of weakening of the material for the intended installation is thus determined. This level is the ratio of the mechanical strength of the material after build-up welding to the mechanical strength of this material on a fresh part.

When the tests on the test pieces are satisfactory and the level exceeds a minimum threshold value, determined experimentally, the installation is validated.

1. Method for the mechanical characterization of a metallic material relative to a metal constituting a part to be repaired and for validating an installation for repairing said part by build-up welding with said metallic material, characterized in that it consists in:
machining a cavity in a bar of said metal;
build-up welding the cavity by means of said installation;
cutting a test piece from said bar so that it has a central zone consisting only of built-up weld metal; and
subjecting the test piece to an axial vibration fatigue test.

2. Method according to claim 1, the installation of which is of the laser build-up welding type.

3. Method according to claim 1 or 2, in which the metallic material is a titanium alloy, especially Ti17 or TA6V.

4. Method according to claim 1, in which the bar has a parallelepipedal shape and the cavity machined in the bar has a shape corresponding to that made in the part to be repaired.

5. Method according to the preceding claim, in which the cavity is cylindrical with an axis transverse to the bar.
